(19) United States
(12) Patent Application Publication
(10) Pub. No.: US 2009/0049122 A1
(43) Pub. Date: Feb. 19, 2009

(54) System and method for providing a video media toolbar

(76) Inventors: Benjamin Wayne, Berkeley, CA (US); Kristopher Joseph Drey, Walnut Creek, CA (US)

Correspondence Address: NIXON PEABODY, LLP, 401 9TH STREET, NW, SUITE 900, WASHINGTON, DC, 20004-2128, US

(21) Appl. No.: 12/196,082

(22) Filed: Aug. 21, 2008

Related U.S. Application Data
(63) Continuation-in-part of application No. 11/889,586, filed on Aug. 14, 2007.
(60) Provisional application No. 60/957,015, filed on Aug. 21, 2007.
(60) Provisional application No. 60/837,328, filed on Aug. 14, 2006.

(51) Int. Cl. G06F 15/16; G06F 3/048; G06F 17/30

(52) U.S. Cl. 709/203; 715/779; 715/765; 707/100; 709/201; 707/E17.044

(57) ABSTRACT

The system and method preferably provides a toolbar to use in a network browser. The toolbar is preferably integrated within a suitable browser program graphical interface as a browser toolbar having its own toolbar graphical interface. The toolbar enables a video file to be selectively uploaded from a publisher computer to a service provider. An HTML video snippet is generated from the video file received from the publisher computer. The HTML video snippet enables access to the stored video file via a browser. The HTML video snippet is distributed to the publisher computer for placement in a publisher web page so as to enable the HTML video snippet to be selected via a browser, In response to the selection of the HTML video snippet, the video data file is played on the networked computer.

### CROSS-REFERENCE TO RELATED APPLICATIONS

This application is a continuation-in-part of U.S. application Ser. No. 11/889,586, filed Aug. 14, 2007, which claims the benefit of U.S. Provisional Application No. 60/837,328, filed Aug. 14, 2006; this application also claims the benefit of U.S. Provisional Application No. 60/957,015, filed Aug. 21, 2007; which applications are incorporated by reference herein.

### BACKGROUND

1. Field

The present invention relates generally to video media, and in particular, a method and system for distributing video data files.

2. Description of Related Art

Web pages on the Internet have grown more sophisticated and inventive since their inception. World Wide Web (WWW) pages are often a company's first introduction to potential readers, customers, and observers and provide a first impression for these users. If a web page does not capture the interest of a site's visitors, the user quickly moves on to alternative sites. Multimedia presentations serve to capture the interest and imagination of users and help companies get their message across. Video gives web site owners the power to educate, inform, demonstrate, and entertain more effectively.

Video inspires. Video engages a visitor. It moves them, educates them, and informs them. Video demonstrates ideas that no photograph can capture, and it immerses visitors in experiences no description can convey. Consumers demand it, bloggers embrace it, and publishers are deploying it in ever more compelling and interesting ways.

The ability of a web site owner to incorporate powerful and intuitive video solutions provides a marked competitive advantage. When a web site provider can offer customized, easily deployed, and seamless integration of video media, they can offer visitors a positive web experience, develop consumer loyalty, and brand recognition.

Video files are large data files, however, consuming bandwidth, storage, and computing resources. Video files are also referred to herein as video data files. There are hundreds of video formats and countless devices and programs capable of performing encoding and decoding on a digital data stream or signal (codecs). Web sites are specialized with an infrastructure that often employs specialized servers for uploading, transcoding, and streaming. To navigate these specialized sites and the hardware involved, there is a steep learning curve, and there is a high up-front investment required with significant on-going maintenance and updating costs.

Many web sites desire the functionality of video, but prohibitively high costs for bandwidth and the nightmare of transcoding formats makes such an investment challenging. Additionally, specialized servers are required for uploading, transcoding, and streaming the video files. Such a high up-front investment and significant ongoing costs make video prohibitive for many web sites.

What is needed is a system and method for providing video media that allows users to quickly and efficiently upload, categorize, and share video media globally or with selected groups.

### SUMMARY

Preferred embodiments of the present invention provide a browser-based toolbar system and method for distributing video data files; while certain other embodiments provide an embedded web page-based system and method for the distribution.

Broadly stated, certain embodiments of the present invention comprise a method of distributing a video data file to a networked computer, the method comprising receiving a request for a toolbar from a client computer; delivering a module to the client computer, the module adapted for installing the toolbar associated with a network browser on the client computer; receiving a video data file from the client computer using the toolbar associated with the network browser on the client computer; storing the video data file received from the client computer; generating an HTML video snippet from the stored video data file, wherein the HTML video snippet enables accessing of the stored video data file; and distributing the HTML video snippet to the client computer to enable placement of the HTML video snippet on a client webpage so as to enable the video data file to be played on the networked computer.

Broadly stated, certain embodiments of the present invention provide a system for distributing a video data file to a networked computer, the system comprising a first computer that provides a module adapted for installation as a toolbar; a second computer configured to operate with the first computer that receives a request from a client computer for the toolbar and delivers the module to the client computer to enable the client computer to transfer a video data file to the second computer using the toolbar; and a third computer that distributes the video data file as an HTML video snippet to the networked computer.

A browser toolbar in accordance with a preferred embodiment of the method and system of present invention adds video functionality and ease-of-use options for the user. The browser toolbar is preferably implemented in a graphical user interface for display on a computer monitor as a row, column, or block of onscreen buttons or icons that, when selected, activate the video capabilities according to embodiments of the present invention. Preferably, the video toolbar may be modified by the end user to customize its appearance and functionality to fit the end user's personal requirements for video.

An advantage of embodiments of the present invention is providing web sites with the capability to accept, post, and manage video media uploaded by users quickly, efficiently, and with an intuitive user interface that requires minimal user investment of resources or technology. Posting a video is as easy as cutting and pasting. There is no need to create memberships on a plethora of web sites. No personal information is required. System navigation and uploading is clean and quick. An embedded toolbar application allows users on any web site to upload, transcode, and post video media. The system and method enable users to video-enable their web page by posting a small snippet of code on a user's web page to embed video capabilities on it. Any web site may be video-enabled within minutes.

Another advantage of embodiments of the present invention is in providing end-to-end solutions that allow web site owners, blogs, and the like of any size to offer video without requiring code development, infrastructure allocation, and software maintenance. Customers are not forced to download extensive software, learn usage behaviors, or accept limitations to their web site experience.

For example, bloggers may add video to web logs with a toolbar in accordance with a preferred embodiment of the present invention. An embed code provides instant encoding, and uploader functionality may be provided in a browser toolbar widget that users can download via a small software application. The browser toolbar does not require that the user have a full web page to place the HTML snippet, but rather a small application that will embed it into the user's browser.

Yet another advantage of embodiments of the present invention is in providing a video media system that stores and streams user videos so that they may be shared quickly and easily. Instead of trying to email cumbersome MPEG (Moving Pictures Experts Group) and AVI (Audio-Video Interleaved) files to user groups, communities, family, and friends, the system and method according to embodiments of the present invention allows the storage of movies in compressed format on the host servers. When a user accesses a stored video, viewing movies is quick. The videos load much faster than with conventional video web sites. According to an alternate embodiment, file transfer protocol (FTP) access is provided for uploading larger video files.

The system according to embodiments of the present invention may be implemented to employ an advertising-driven service, so that there are no costs for users to access the system. In such an implementation, the costs of technology, bandwidth, storage, and streaming the videos may be borne by the video service provider or a partner, rather than by the end users.

These and other advantages and features of embodiments of the present invention will become more apparent from the following detailed description of the embodiments of the present invention when viewed in conjunction with the accompanying drawings.

### BRIEF DESCRIPTION OF THE DRAWINGS

FIGS. 1A-1D are schematic flow diagrams illustrating the operation and the relationships between parties in accordance with one embodiment of the present invention.

FIG. 2 is a schematic diagram illustrating a system for providing video media on a web site in accordance with one embodiment of the present invention.

FIG. 3 is a schematic diagram illustrating components of a service provider used to provide video media on a web site in accordance with one embodiment of the present invention.

FIG. 4 is an example screen shot of the HTML snippet rendered by a browser in accordance with one embodiment of the present invention.

FIG. 5 is an example screen shot of an instantiation of the HTML snippet rendered by a browser in accordance with one embodiment of the present invention.

FIG. 6 is an example screen shot of a conversion module rendered by a browser in accordance with one embodiment of the present invention.

FIG. 7 is an example screen shot of a newly displayed conversion module after a video data file is uploaded in accordance with one embodiment of the present invention.

FIG. 8 is an example graphical presentation of a video toolbar in accordance with a preferred embodiment of the present invention.

FIGS. 9A-9D are schematic flow diagrams illustrating the operation and the relationships between parties according to a preferred embodiment of the method and system of the present invention.

### DETAILED DESCRIPTION

The following detailed description of embodiments of the invention refers to the accompanying drawings and to certain embodiments including preferred embodiments, but the detailed description does not limit embodiments of the invention. The scope of embodiments of the invention is defined by the appended claims and equivalents as it will be apparent to those of skill in the art that various features, variations, and modifications can be included or excluded based upon the requirements of a particular use.

According to preferred embodiments of the present invention, a browser-based toolbar system and method for distributing video data files is provided; while according to certain other embodiments, an embedded web page-based system and method for the distributing is provided. Embodiments of the present invention extends the functionality of current video hosting services and techniques by providing a system and method that allows any web site to instantly enable its users to publish video on the Internet. According to a preferred embodiment of the system and method of the present invention, a web site publisher is provided with the ability to instantly add a toolbar to a browser or web site that converts a video data file to an HTML video snippet. According to an alternative embodiment of the present invention, the video data file is distributed to one or more networked computers by delivering a snippet conversion module to a partner computer, where the snippet conversion module is copied into a partner web page. The video data file is received from a publisher computer using the snippet conversion module from the partner web page in accordance with the alternative embodiment.

According to embodiments of the present invention, an HTML video snippet is generated from the stored video data file received from the publisher computer, and the HTML video snippet is used to access the stored video data file. The system and method distributes the HTML video snippet to the publisher computer to enable the publisher to place the HTML video snippet in a publisher web page that is accessible by the networked computer. Accessing the HTML video snippet in a publisher web page via a browser on the networked computer enables the rendering of the HTML video snippet as the uploaded video data file.

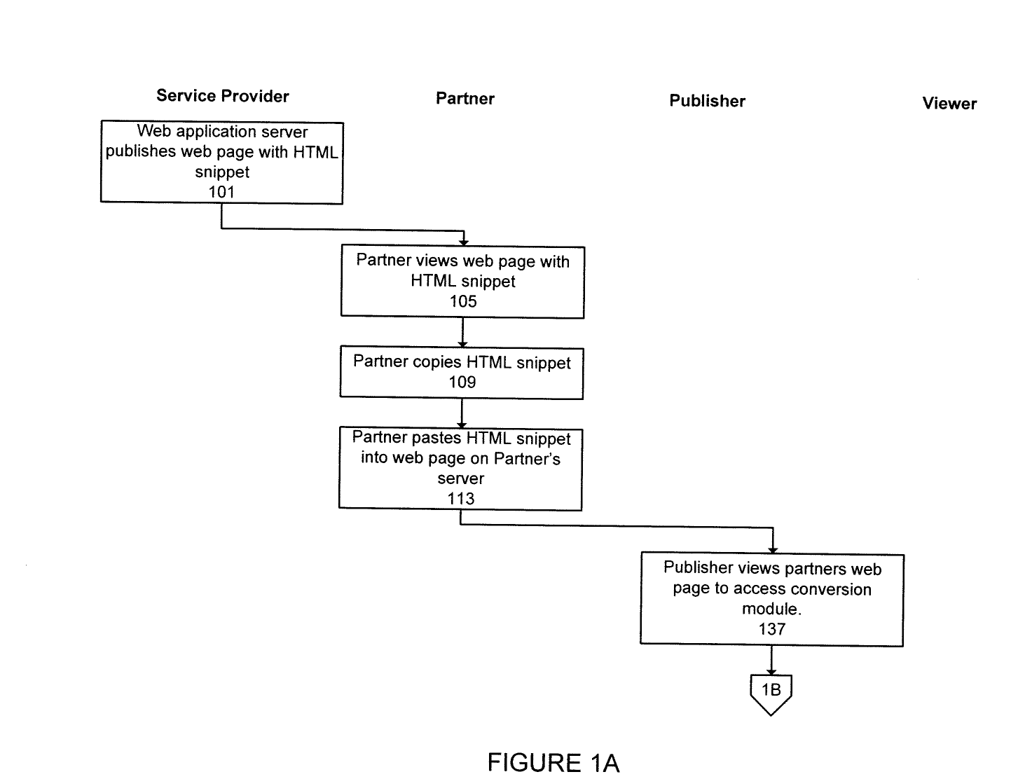

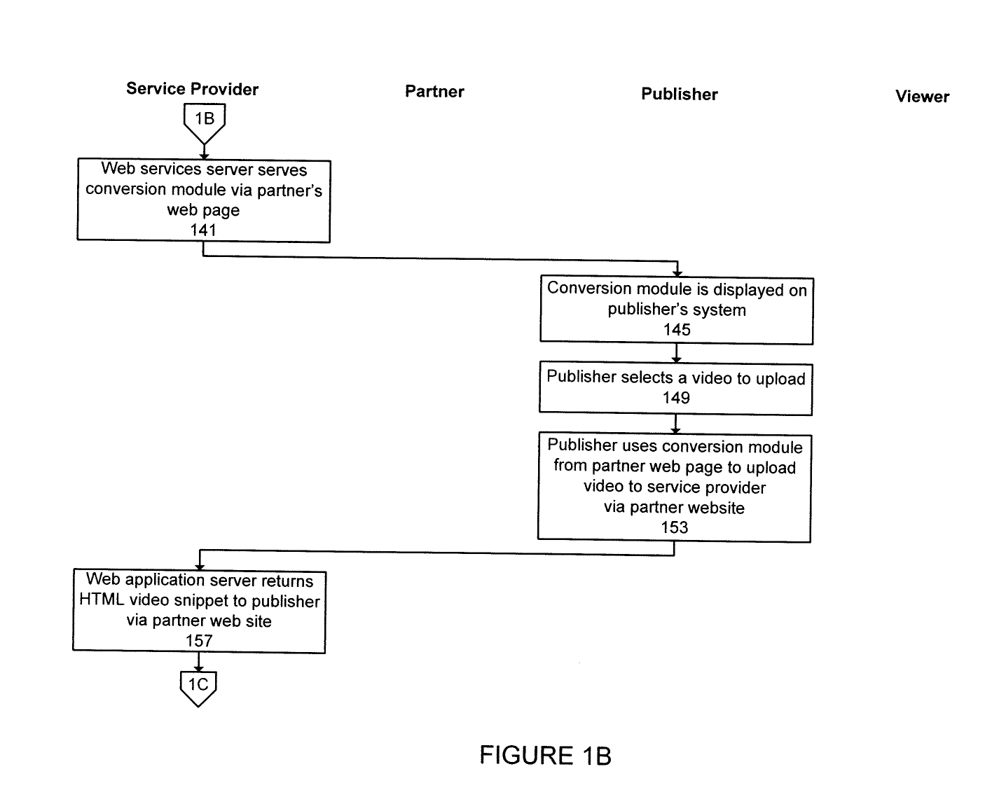

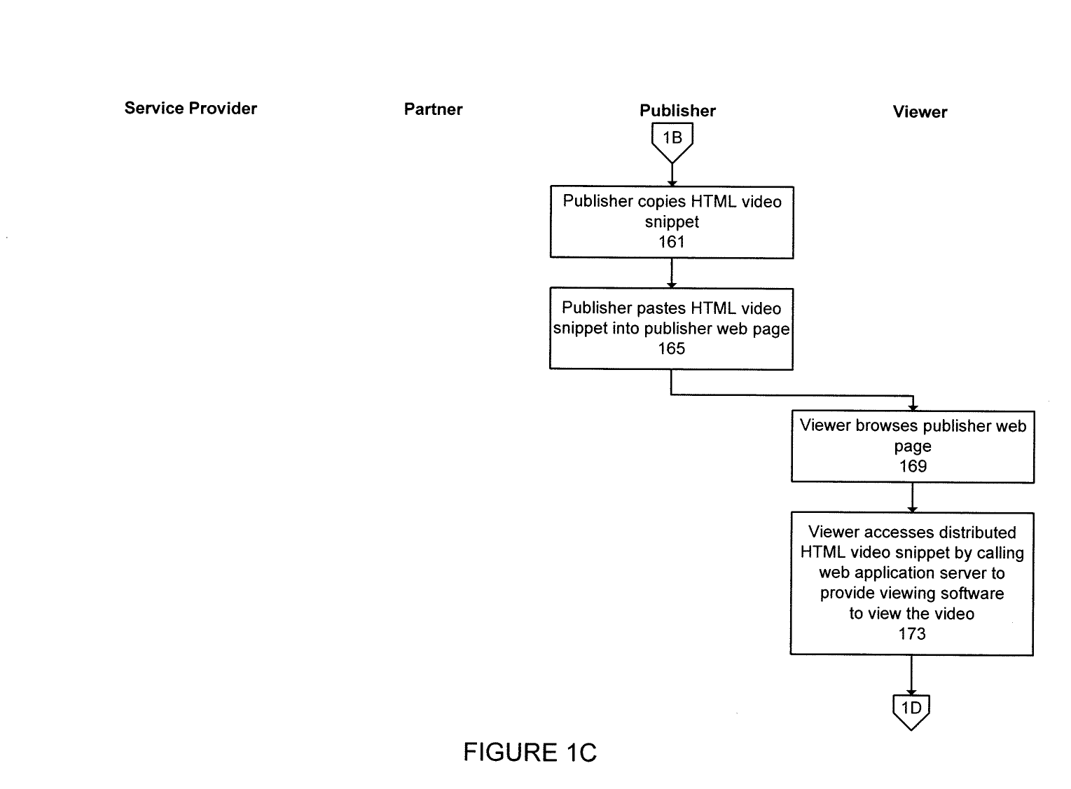

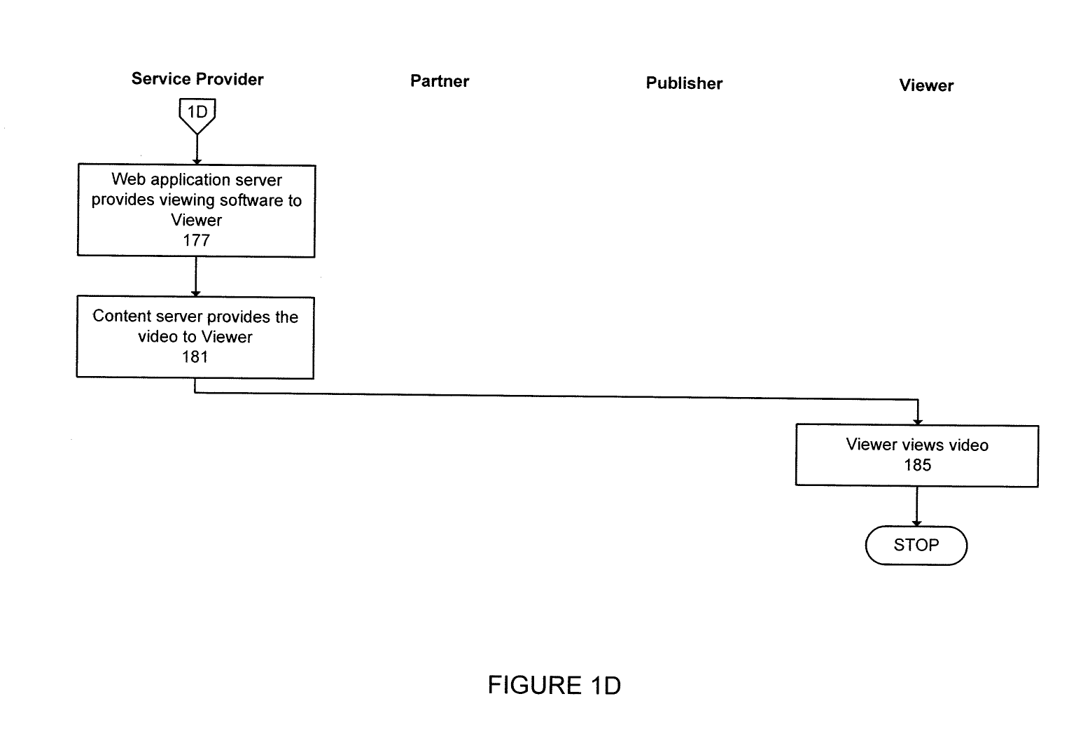

FIGS. 1A-1D are flow diagrams illustrating the operation of certain alternate embodiments of the present invention and the relationships between parties carrying out a method in accordance with those embodiments of the present invention. In the example in FIG. 1A-1D, four parties participate in the process for providing video media on a web site. The parties may include a video service provider such as Fliqz, as well as a partner (client) such as CraigsList. Additionally, the parties may include a publisher of a video, such as a person placing an advertisement for an apartment on CraigsList. Further, a viewer, or end-user, or the like, that ultimately views the video is also a party to certain embodiments of the present invention described. In the following description, it may be useful to follow the flow in the example illustrated in FIGS. 1A-1D as a publisher uses the video service provider to place a video in a partner's web site in hopes that a viewer will view the video and also respond to a corresponding advertisement.

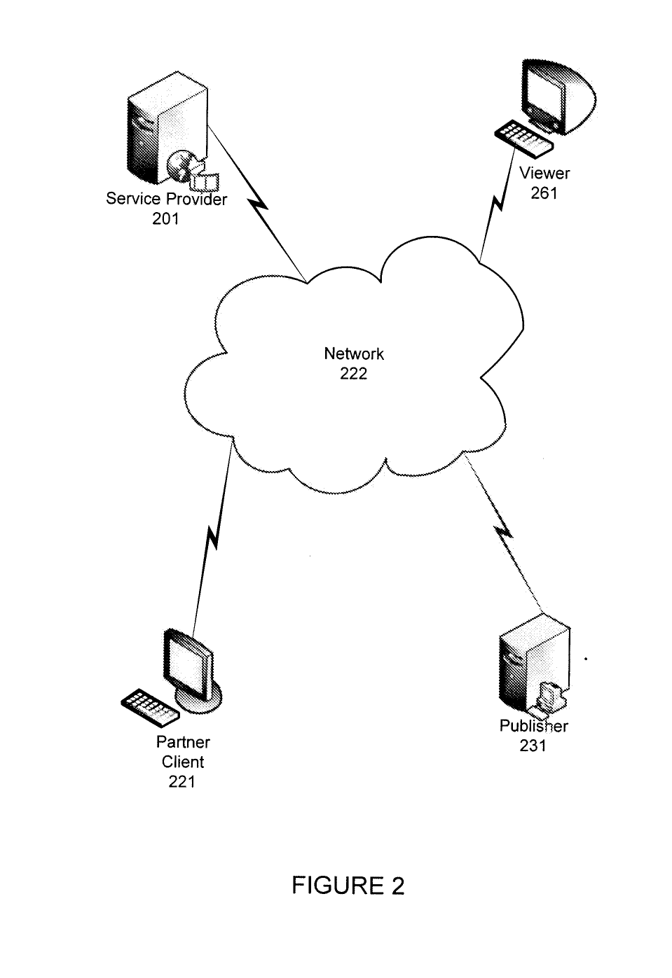

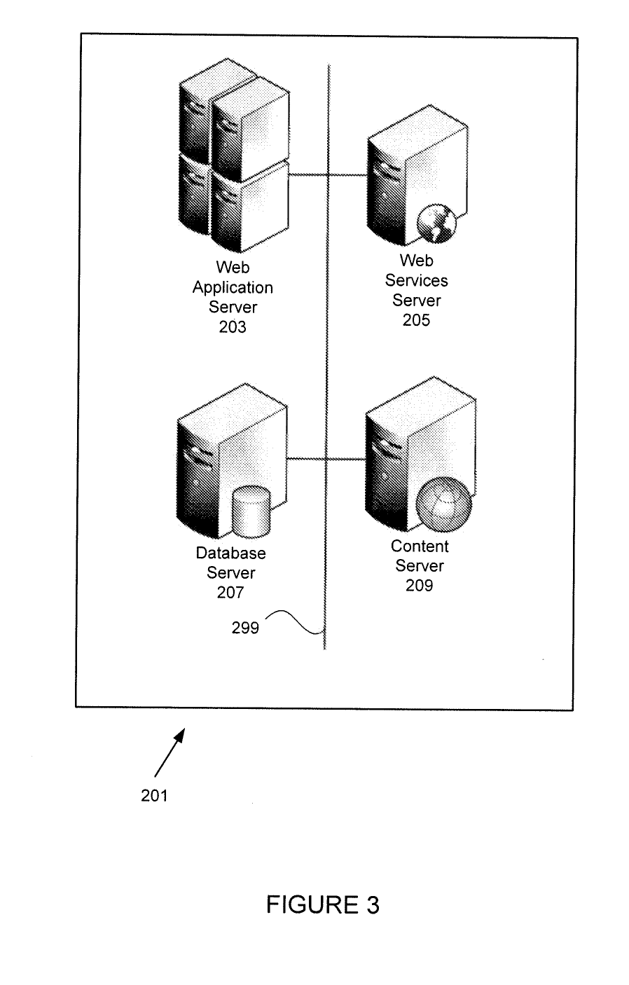

FIGS. 1A-1D may be better understood with reference to the system components of FIG. 2 as well as the modules of the service provider shown in FIG. 3. For example, FIG. 2 illustrates a system for providing video media on a web site in accordance with embodiments of the present invention while FIG. 3 is a schematic diagram illustrating components of a service provider used to provide video media on a web site in accordance with embodiments of the present invention.

According to the alternate embodiment of the present invention illustrated in the example in FIGS. 1A-1D, four parties participate in the process for providing video media on a web site. As shown in FIG. 2, the parties may include the video service provider 201, a partner 221 (also referred to as a client the alternate embodiment illustrated in FIGS. 1A-1D), a publisher 231, and a viewer 261. The parties 201, 221, 231, 261 may be connected by a computer network 222, such as the Internet, an intranet, or the like. In one embodiment, each party 201, 221, 231, 261 performs a number of steps in the process, and each party 201, 221, 231, 261 produces one or more web pages, except the viewer 261, who does not produce a web page in the present embodiment.

Alternatively, the partner and publisher may be the same party. For example, an advertiser with their own web site may use the system and method according to an embodiment of the present invention to copy and paste an HTML snippet from the video service provider to the advertiser's own web site, whereby a visitor (that is, a viewer) to the advertiser's web site may view a video data file by way of accessing an HTML video snippet from the video service provider. Thus, the HTML snippet is a web tool, i.e., a web widget, that may be used by a publisher and/or a partner to initiate the video uploading process that ultimately returns an HTML video snippet with which a viewer may view the uploaded video data file.

Referring again to FIGS. 1A-1D and to FIGS. 2 and 3, the web application server 203 of video service provider 201 publishes a web page with an HTML snippet in step 101. While video service provider 201 shown in FIG. 3 includes web application server 203, web services server 205, database server 207, and content server 209 connected by bus 299, video service provider 201 may include these servers 203, 205, 207, 209 in a single physical unit, or in a distributed computing environment.

The system that supports embodiments of the method of the present invention may be an n-tiered thin client Internet application. For example, content server 209 may include a web server that stores and publishes video files. Database server 207 may be a server that makes a database available to the web services server 205. Web services server 205 may be a web server that publishes XML web services; these services act as intermediaries between the content server 209 and the database server 207 and the web application server 203. Web application server 203 publishes HTML web pages dynamically generated by software that depends upon the web services server 205 or publishes static HTML pages.

Further, any one of servers 203, 205, 207, 209 may be physically and/or functionally combined with one or more of the other servers 203, 205, 207, 209 or may be further separated depending upon the particular use and environment of the video service provider 201. For clarity and brevity, servers 203, 205, 207, 209 are shown within video service provider 201. A video service provider is also referred to herein as a service provider.

The other parties 221, 231, 261, shown in FIG. 2, that access network 222 in the system with which to provide video media on a web site have their own infrastructure that supports their portion of the process. For example, partner 221, publisher 231, and viewer 261 may connect to the computer network 222 with their own devices or modules, such as servers and/or clients, or the like.

Referring again to FIG. 1A, in step 101, video service provider 201 publishes a web page with an HTML snippet using web application server 203. Once web application server 203 publishes the web page with the HTML snippet, a partner (client) 221 views the web page in step 105.

For example, the snippet of HTML may appear as follows:

<iframe src=“http://www.fliqz.com/Fliqzster/Fliqzsterupload.aspx?Type=Hor&skin=” frameBorder=“no” scrolling=“no” style=“width: 470px; height: 60px; margin: 0px; padding: 0px;”></iframe>

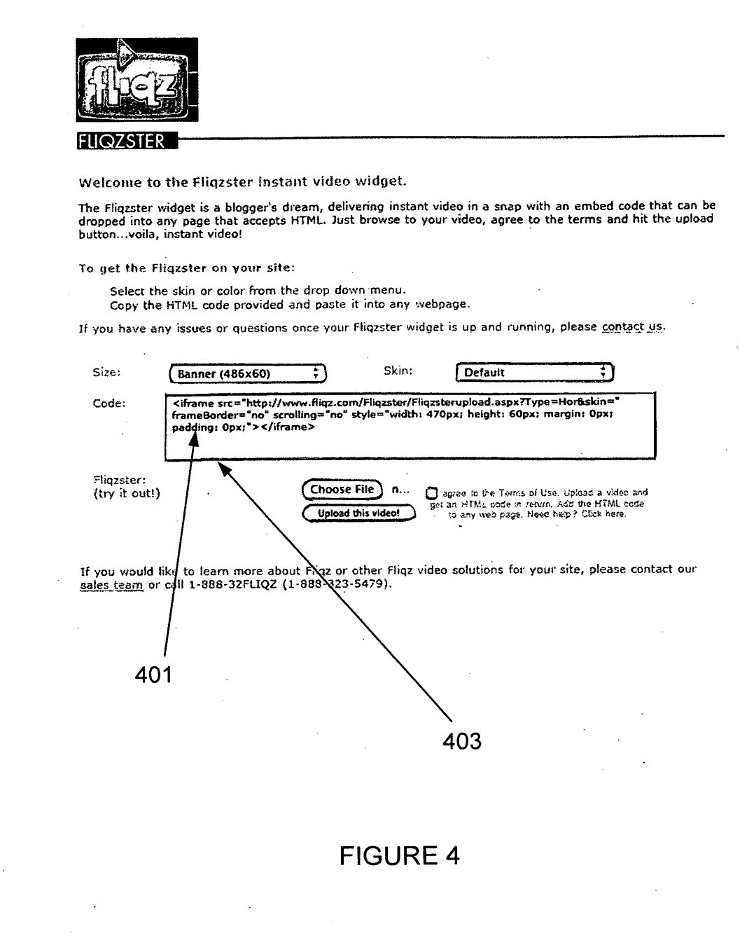

As shown in FIG. 4, this HTML snippet 401 is rendered by a browser and shown in the “code” box 403. The HTML snippet 401 is delivered by serving it as a web page by the web application server 203. In accordance with certain embodiments of the present invention, the HTML snippet 401 is the same, regardless of the web page with which it is served. In this manner, publishers may easily access, copy, and use the HTML snippet 401, via a partner's web page, as the means for providing video media on their web site, regardless of the specific location, address, or URL (Uniform Resource Locator) of the particular web site. Alternatively, the publisher 231 and partner client 221 are the same party, wherein the publisher would access the HTML snippet 401 at the publisher's web page.

According to the example alternate embodiment operating as illustrated in FIGS. 1A-1D, the HTML snippet that is served is the same HTML code regardless of the identity of the recipient or the specific video data file to be uploaded. The partner selects a number of options presented by the HTML snippet that dictate the presentation of the soon-to-be-delivered conversion module. Once the options are selected by the partner, they are transferred back to the video service provider, and the video service provider returns a conversion module to the partner with the appearance as specified by the partner-selected options. The conversion module is used by the publisher to indicate the video data file to be uploaded. Once the publisher uploads a video data file to the video service provider using the conversion module, an HTML video snippet is returned. The HTML video snippet is different for each video data file and will be used by a viewer to access the video data file now stored by the video service provider. Thus, HTML snippet, conversion module, and HTML video snippet as referred to herein are different from each other, and are in fact the web pages served by the parties.

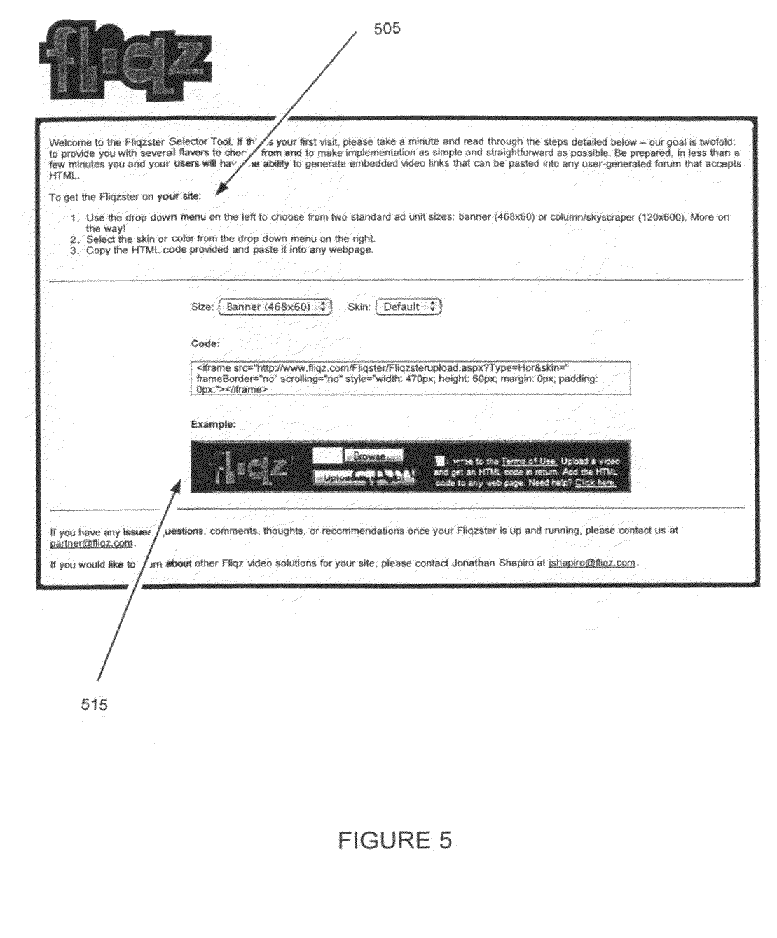

Returning to FIG. 1A, in step 105, partner 221 views the web page with the HTML snippet. Partner 221 copies the HTML snippet from the web page in step 109, and in step 113 the partner 221 pastes it into another web page of his choosing called the “partner web page”. The partner web page may be stored on a partner's server, or may be stored at a separate facility. This web page might be, for example, the home page of a portal site such as CraigsList or MySpace. An example of incorporation of the HTML snippet is shown in FIG. 5, where instructions 505 are provided with which partner 221 may set up the appearance of the HTML snippet 515. Once the options for the appearance are selected by the partner, they are transferred back to the video service provider, and the video service provider returns a conversion module to the partner with the appearance as specified by the partner-selected options.

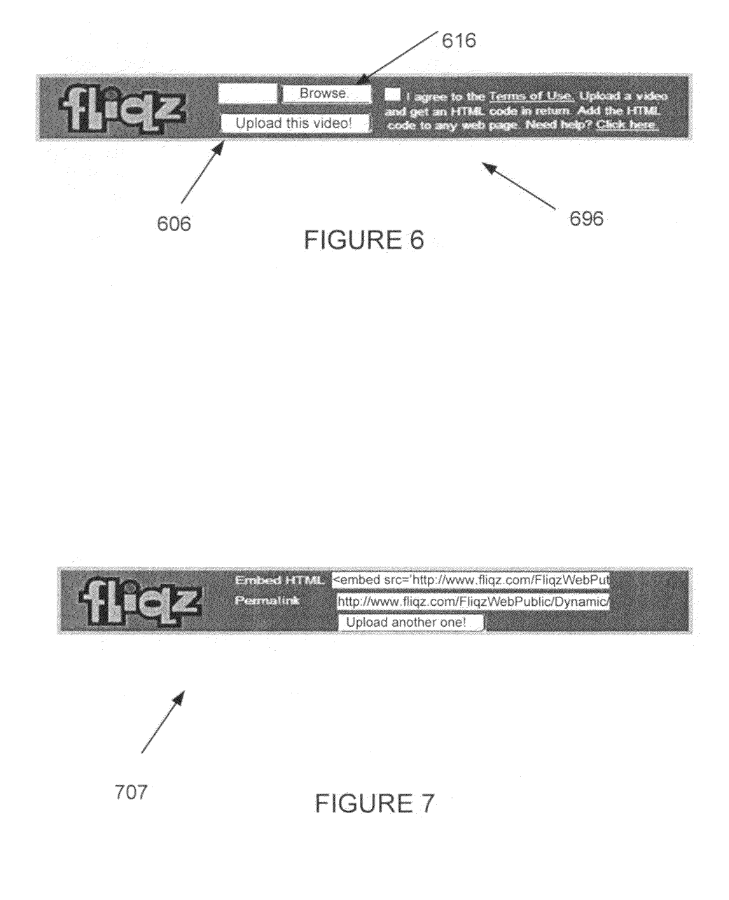

In step 137 in FIG. 1A, publisher 231 views the web page of partner 221 to access and place a conversion module. As shown in FIG. 1B in step 141, web services server 205 of service provider 201 serves a conversion module to the publisher 231 via the partner's web page. The conversion module is displayed on the system of the publisher 231 in step 145. The appearance of the conversion module within the web page of the partner 221 is the result of the HTML markup used in the conversion module that provides this web widget functionality. An example of the conversion module 696 is shown in FIG. 6.

In step 149, the publisher 231 uses the conversion module appearing on the partner web page to select a video file to upload, that resides on the publisher's computer, by using either the “browse” button 616, or by entering a location and file name to be uploaded. In step 153, the publisher uses the conversion module 696 to upload a video to service provider 201 via the web site of partner 221. In response to the publisher 231 specifying a file and clicking the “Upload this video” button 606, the video data file is uploaded to the service provider 201.

In step 157, web application server 203 returns a snippet of HTML code in response to receipt of the uploaded video data file, and the displayed conversion module changes its appearance. An example of the newly displayed conversion module 707 is shown in FIG. 7.

For example, the displayed conversion module now displays a snippet of HTML code approximately as follows:

<embed src=‘http://www.fliqz.com/FliqzWebPublic/Dynamic/FliqzwebPublic.swf?skinPath=http://www.fliqz.com/FliqzWebPublic/Dynamic&file=22587&autoplay=0&progressive=1’ type=‘application/x-shockwave-flash’ width=‘500’ height=‘470’></embed>

This snippet of HTML code is also called the HTML “video snippet” 709 as shown partially displayed in the exemplary “embed HTML” field in FIG. 7. The HTML video snippet 709 returned is slightly different for each uploaded video. As a result, the HTML video snippet 709 may be rendered by a browser as the specific video data file that was uploaded.

In step 161 shown in FIG. 1C, publisher 231 copies the HTML video snippet 709 provided via the partner's web site. In step 165, publisher 231 pastes the HTML video snippet 709 into a web page of the publisher 231. The publisher web page might be, for example, a user page within a portal web site such as a posting on CraigsList, a member page on MySpace, or the like.

In step 169, viewer 261 browses the publisher web page when accessing the computer network, or the Internet, or the like. In step 173, viewer 261 accesses the distributed HTML video snippet 709 by calling web application server 203 of the service provider 201.

As shown in FIG. 1D in step 177, web application server 203 provides viewing software to the viewer 261 with which the viewer 261 may watch the video data file. This lightweight software may be a Flash player or the like. The lightweight software provided to the viewer 261 then calls content server 209 to provide the specific video data file that corresponds to the distributed HTML video snippet. In step 181, content server 209 provides the appropriate selected video data file to viewer 261. The browser of viewer 261 renders the video snippet as the video previously uploaded and stored in content server 209. The viewer 261 may then view the video by clicking on the rendered snippet in step 185. For example, if the publisher web page was a posting on CraigsList offering an apartment for rent, the video might be a video tour of the apartment. This illustrates that the system of FIG. 2 is extremely flexible and responsive to individual video data file requirements for a particular environment.

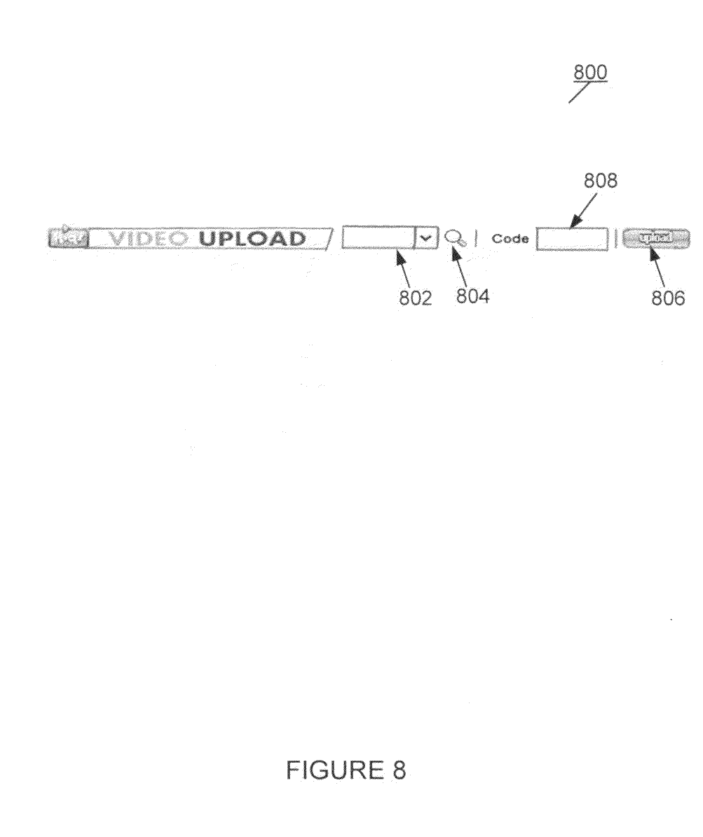

FIG. 8 is an example graphical presentation of a video toolbar in accordance with a preferred embodiment of the method and system of the present invention. Providing the web site tool as a video toolbar enables quicker access and implementation. The browser toolbar in accordance with a preferred embodiment of the present invention adds video functionality and ease-of-use options for the user. The toolbar according to a preferred embodiment is preferably integrated within a suitable browser program graphical interface as a browser toolbar with its own graphical interface. The publisher preferably obtains the toolbar directly from the service provider, or, alternatively, via a third party partner website.

As an overview of an example of the preferred embodiment of the present invention, bloggers may add video to web logs using the toolbar. An embed code, provided via the toolbar, provides instant encoding. Uploader functionality is preferably also provided in the browser toolbar. The browser toolbar, also referred to as a widget, is obtained by installing a small software application, also referred to herein as a module, that users can download and then integrate in their browser application. The toolbar is embedded into the user's browser, i.e., the toolbar resides in the browser itself such that a toolbar graphical interface is integrated into the browser application user interface.

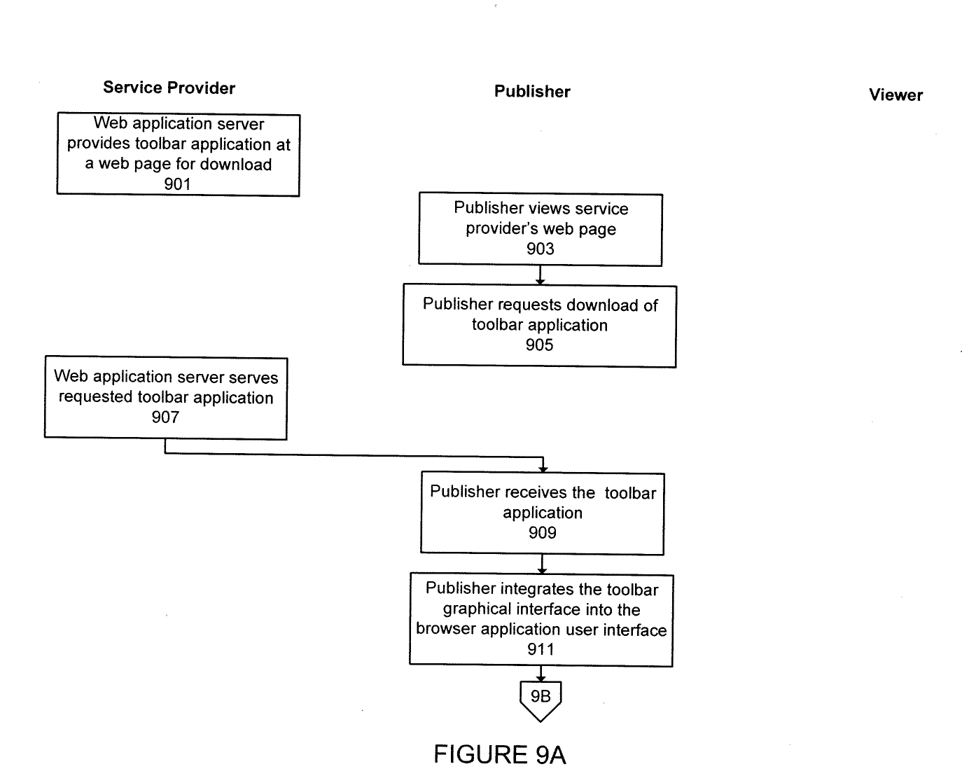

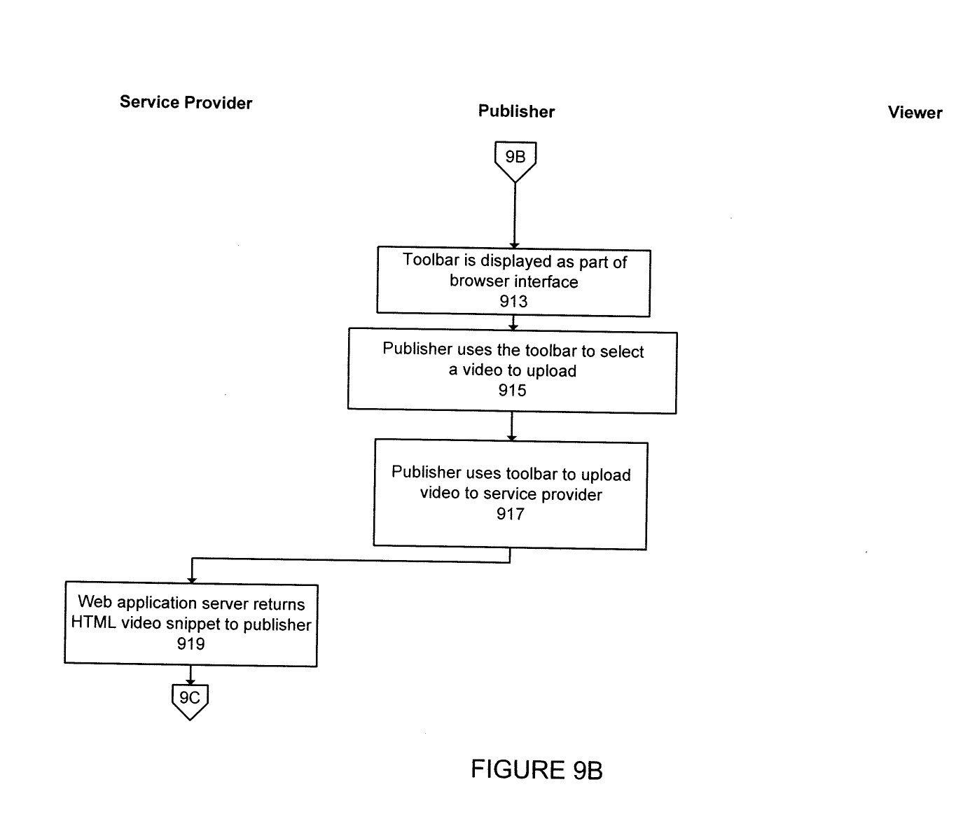

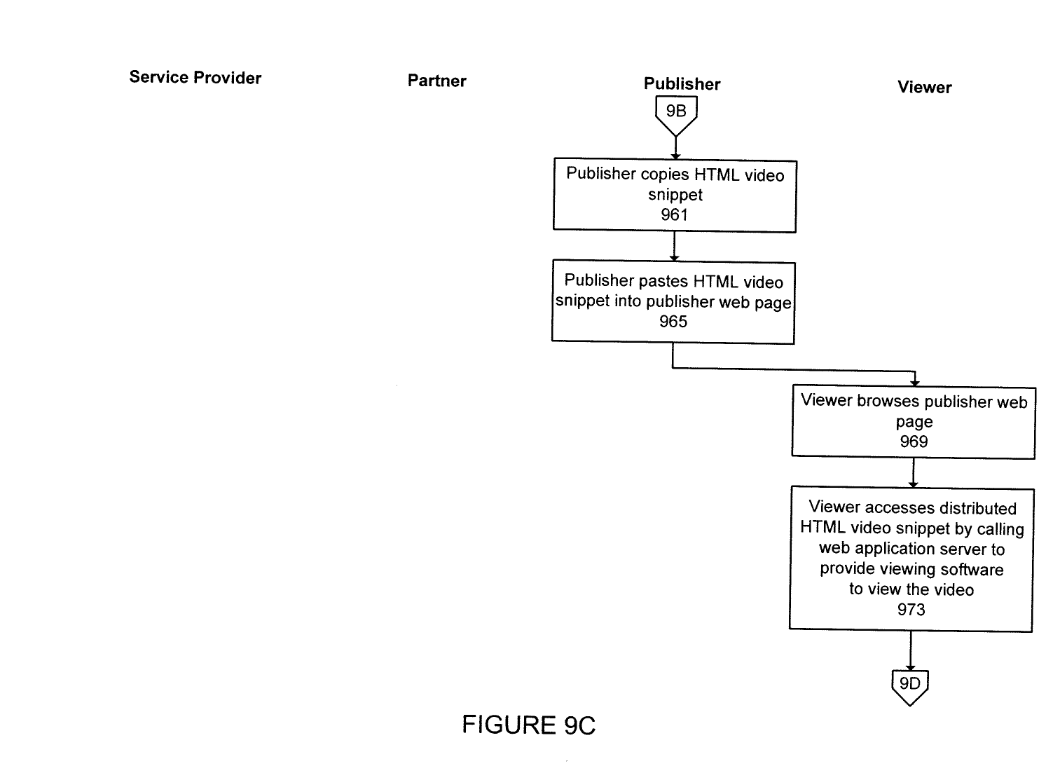

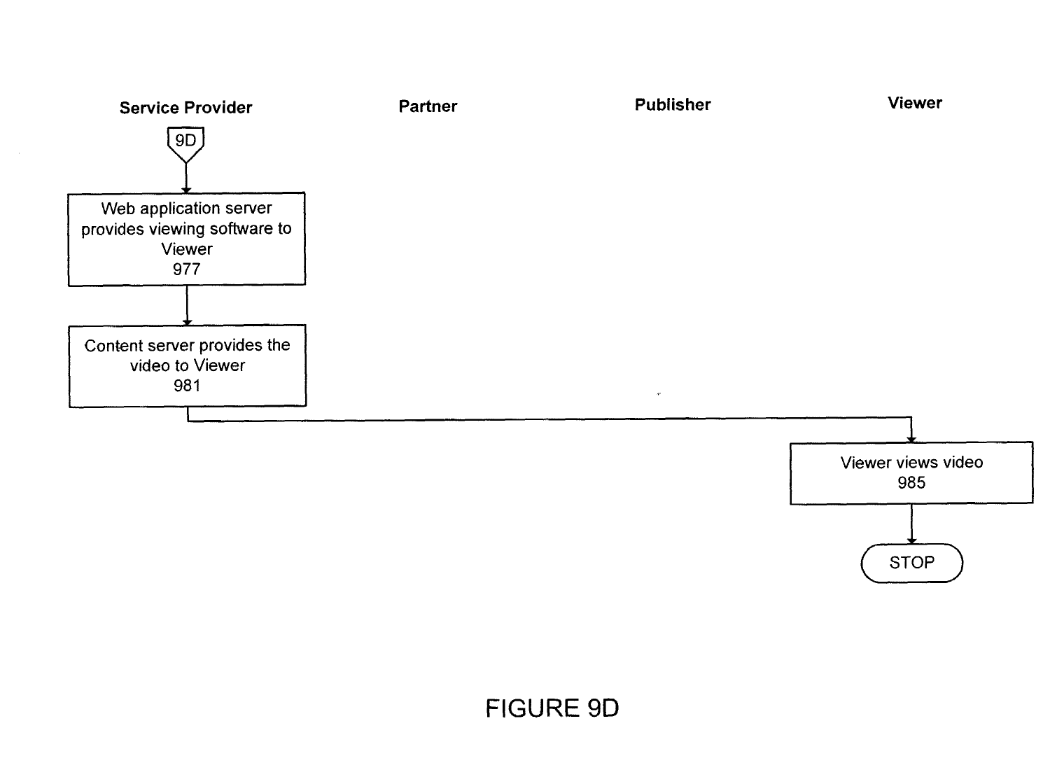

FIGS. 9A-9D are schematic flow diagrams illustrating the operation and the relationships between parties carrying out a method in accordance with the preferred embodiment of the present invention. FIGS. 9A-9D may be better understood with reference to the system components of FIG. 2 as well as the modules of the service provider shown in FIG. 3. For example, FIG. 2 illustrates a system for providing video media on a web site in accordance with certain embodiments of the present invention while FIG. 3 is a schematic diagram illustrating components of a service provider used to provide video media on a Web site in accordance with certain embodiments of the present invention.

In the example in FIG. 9A-9D, three parties participate in the process for providing video media on a web site. The parties include the video service provider 201, a publisher 231, and a viewer 261, shown in FIG. 2. The publisher 231 and partner 221 from FIG. 2 are preferably the same party. Alternatively, a partner 221 may be a separate party who participates by downloading the toolbar from the service provider 201, integrating the toolbar into the partner's web page, and enabling the publisher 231 to use the toolbar via the partner's web page; e.g., for web and browser-based blog editing by a publisher at a partner's web site. The video service provider 201, a publisher 231, a viewer 261, and partner computer 231 may be connected by a computer network 222, such as the Internet, an intranet, or the like.

While video service provider 201 shown in FIG. 3 includes web application server 203, web services server 205, database server 207, and content server 209 connected by bus 299, video service provider 201 may include these servers 203, 205, 207, 209 in a single physical unit, or in a distributed computing environment.

A system that supports the method according to a preferred embodiment of the present invention may be an n-tiered thin client Internet application. For example, content server 209 may include a web server that stores and publishes video files. Database server 207 may be a server that makes a database available to the web services server 205. Web services server 205 may be a web server that publishes XML web services. These services act as intermediaries between the content server 209 and the database server 207 and the web application server 203. Web application server 203 publishes HTML web pages dynamically generated by software that depends upon the web services server 205 or publishes static HTML pages.

Further, any one of servers 203, 205, 207, 209 may be physically and/or functionally combined with one or more of the other servers 203, 205, 207, 209 or may be further separated depending upon the particular use and environment of the video service provider 201. As described above, for clarity and brevity, servers 203, 205, 207, 209 are shown within video service provider 201.

The other parties 231, 261, and alternatively 221, shown in FIG. 2, that access network 222 in have their own infrastructure that supports their portion of the process. For example, partner 221, publisher 231, and viewer 261 may connect to the computer network 222 with their own devices or modules, such as servers and/or clients, or the like.

Referring again to FIGS. 9A-9D and to components of FIGS. 2 and 3, the web application server 203 provides a toolbar application at a web page that available for download, in step 901. In step 903, the publisher 231 views the service provider's web page. In step 905, the publisher 231 requests download of the toolbar application provided by the web application server 203. In step 907, the web application server serves the requested toolbar application to the publisher 231; which the publisher 231 receives, in step 909. In step 911, the publisher 231 integrates the toolbar graphical interface into the browser application user interface; i.e., the toolbar application is installed such that the toolbar resides in the browser itself. In step 913, shown in FIG. 9B, the toolbar is displayed as part of browser interface of the publisher.

The toolbar according to a preferred embodiment is referred to generally herein as a video media toolbar or video toolbar, and also is referred to herein as a browser-toolbar or browser toolbar for emphasizing the browser-based aspect. The toolbar in accordance with a preferred embodiment of the present invention may be implemented in a graphical user interface on a computer monitor as a row, column, or block of onscreen buttons or icons that, when clicked, activate the video capabilities of embodiments of the present invention. The video toolbar may be modified by the end user to customize its appearance and functionality to fit the user's personal requirements for video.

An example of the toolbar 800 is shown in FIG. 8. In FIG. 8, the toolbar 800 is shown by itself, without the rest of the browser application user interface into which the toolbar user interface is integrated.

In step 915, shown in FIG. 9B, the publisher 231 uses the toolbar to select a video file that resides on the publisher's computer. The exemplary toolbar 800 in FIG. 8 includes a browse window/button 802, shown next to magnifying glass type icon 804, to enable a user to browse file, find a desired video data file and select it for uploading. The arrow 804 enables a user to view a list of previously uploaded files. Preferably, the user is prompted to agree to terms for use of the toolbar before it can be used to upload video data files.

In step 917, the publisher 231 uses the toolbar to upload video to service provider 201. An upload button 806 is provided in the toolbar in the example in FIG. 8, for use by the user to upload a video file the user has selected to upload. In response to selection of the upload button 806, an upload of the video data file occurs.

The web application server 203 of service provider 201 receives the video file from the publisher and preferably stores the video file. In step 919, for the received video file, the web application server 203 returns a snippet of HTML code to publisher 231. The snippet of HTML code enables access to the video file from the service provider 201. The snippet of HTML code is different for each video data file and may be used by a viewer to access the video data file now stored by the video service provider.

In response to receipt of the snippet of HTML code, the code is embedded in the toolbar code field 808 in the exemplary toolbar 800 in FIG. 8. The code represents an HTML video snippet that can be copied/pasted by the publisher directly into their web page to enable a viewer of their page to access the video. The code is selectable by the publisher for copying, even though the code might not fit within the displayed area shown in 808 in the example in FIG. 8. The publisher 231 is also referred to herein as the user or publisher/user, where the term user indicates the publisher party in the method according to embodiments of the present invention. It should be appreciated that the other parties that participate in the method do, in some sense, “use” embodiments of the invention.

In step 961, shown in FIG. 9D, publisher 231 pastes the HTML video snippet into publisher web page. In step 965, publisher 231 pastes the HTML video snippet into a web page of the publisher 231 where insertion of a link to a video file is desired. The publisher web page might, for example, be a blog editing and posting page within a portal web site of a third party, or any web page where insertion of a link to a video file is desired.

In step 969, viewer 261 browses the publisher web page, e.g., when accessing the computer network, or the Internet, or the like. In step 973, viewer 261 accesses the distributed HTML video snippet by calling web application server 203 of the service provider 201.

As shown in FIG. 9D in step 977, web application server 203 provides viewing software to the viewer 261 with which the viewer 261 may watch the video data file. This lightweight software may be a Flash player or the like. The lightweight software provided to the viewer 261 then calls content server 209 to provide the specific video data file that corresponds to the distributed HTML video snippet.

In step 981, content server 209 provides the appropriate selected video data file to viewer 261. In step 985, the viewer 261 views the video, preferably by clicking on the rendered video snippet on the viewed web page, in response to, the browser of viewer 261 renders the video previously uploaded and stored in content server 209, for display.

Advantageously, with the toolbar according to the preferred embodiment of the present invention, the publisher does not need to ever leave their blog post or whatever browser window the publisher/user is working on; the blog post or window in which the user desires to embed video. The toolbar enables the user to upload the video file, gets the embed code in the browser toolbar for easy copy/paste directly in the same web page the publisher/user is uploading from; the same browser window that the user already has open.

Advantageously, the publisher/user doesn't have to browse, tab or click away when uploading the video and getting back an embed code in the toolbar that the publisher/user can be copy/paste into the blog post or other window.

The browser toolbar is preferably incorporated within a suitable browser program. All server polls are performed in a thread protected environment so that user actions are not slowed or hindered. Procedures to handle outages are included in the toolbar according to embodiments of the present invention and are invisible to the end user. A worker-thread tests for the presence of a network connection and a URL is provided so that the system according to embodiments of the present invention may verify that a server is available. The system spawns a thread that checks to make sure that a server connection is available. If a server is not available, HTTP communications within the toolbar are disabled.

In one embodiment of the present invention, the toolbar is designed to operate in a “thin” framework. The toolbar may be designed using Visual C 7.1 and ATL and STL. In this embodiment, there are no third party tools and no utilization of any “fat” layers such as MFC or .NET.

Further, in one embodiment of the present invention, the toolbar may be constructed based on a dynamic XML configuration file. The toolbar may download this file from a predetermined server at a specified interval, such as every twenty-four hours, at startup, or at other suitable intervals. If an Internet connection is unavailable, the toolbar will use the current configuration residing in an encrypted file within an application data folder. The polling interval may also be a part of the SML configuration so that a user may adjust the interval as necessary.

The XML configuration file may be formatted using UTF8 (8-bit UCS/Unicode Transformation Format). UTF8 is a variable-length character encoding for Unicode. UTF8 may represent any character in the Unicode standard, yet the initial encoding of byte codes and character assignments for UTF-8 is consistent with ASCII.

Further, in one embodiment of the present invention the toolbar is dynamically built at run-time based on a configuration file. The configuration file enables a user to add and remove general items such as buttons/images and to modify text. Special functionality may be designated within the configuration file. An example graphical presentation of a video toolbar in accordance with an exemplary embodiment of the present invention is illustrated in FIG. 8.

The method according to embodiments of the present invention is reliably fast and accurate, and provides a method for providing video media on a web site to facilitate further web traffic, information dissemination, and entertainment by providing intuitive implementation of video media files.

The devices and subsystems of the embodiments of FIGS. 1-9 are for illustrative purposes, as many variations of the specific hardware used to implement the embodiments are possible, as will be appreciated by those skilled in the relevant arts. For example, the functionality of one or more of the devices and subsystems of the embodiments of FIGS. 1-9 can be implemented via one or more programmed computer systems or devices.

To implement such variations as well as other variations, a single computer system can be programmed to perform the special purpose functions of one or more of the devices and subsystems of the embodiments of FIGS. 1-9. On the other hand, two or more programmed computer systems or devices can be substituted for any one of the devices and subsystems of the embodiments of FIGS. 1-9. Accordingly, principles and advantages of distributed processing, such as redundancy, replication, and the like, also can be implemented, as desired, to increase the robustness and performance of the devices and subsystems of the embodiments of FIGS. 1-9.

The devices and subsystems of the embodiments of FIGS. 1-9 can store information relating to various processes described herein. This information can be stored in one or more memories, such as a hard disk, optical disk, magneto-optical disk, RAM, and the like, of the devices and subsystems of the embodiments of FIGS. 1-9. One or more databases of the devices and subsystems of the embodiments of FIGS. 1-9 can store the information used to implement embodiments of the present invention. The databases can be organized using data structures (e.g., records, tables, arrays, fields, graphs, trees, lists, and the like) included in one or more memories or storage devices listed herein. The processes described with respect to the embodiments of FIGS. 1-9 can include appropriate data structures for storing data collected and/or generated by the processes of the devices and subsystems of the embodiments of FIGS. 1-8 in one or more databases thereof.

All or a portion of the devices and subsystems of the embodiments of FIGS. 1-9 can be conveniently implemented using one or more general purpose computer system, two linked general purpose computer systems, microprocessors, digital signal processors, micro-controllers, and the like, programmed according to the teachings of embodiments of the present invention, as will be appreciated by those skilled in the computer and software arts. Appropriate software can be readily prepared by programmers of ordinary skill based on the teachings of the embodiments, as will be appreciated by those skilled in the software art. Further, the devices and subsystems of the embodiments of FIGS. 1-9 can be implemented on the World Wide Web. In addition, the devices and subsystems of the embodiments of FIGS. 1-9 can be implemented by the preparation of application-specific integrated circuits or by interconnecting an appropriate network of conventional component circuits, as will be appreciated by those skilled in the electrical arts. Thus, the embodiments are not limited to any specific combination of hardware circuitry and/or software.

As stated above, the devices and subsystems of the embodiments of FIGS. 1-9 can include computer readable media or memories for holding instructions programmed according to the teachings of embodiments of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

In order to further minimize the overall processing time required to deliver, video data files, the system according to embodiments of the present invention may index video information content and store these indexed data within the devices of the system 201. If a partner, publisher, or viewer anticipates that they will view the same video data file in the future, the system can index the video data files and store the results. When an indexed and stored video data file is then retrieved or accessed, the profile, network, content characteristics, as well as display characteristics may be retrieved for those stored results, and the relevant materials may simply be updated with additional data that may now be accessible. The information content previously available may be recalled from the system 201 to reduce the overall execution time.

The foregoing description of the aspects and embodiments of the present invention provides illustration and description, but is not intended to be exhaustive or to limit embodiments of the invention to the precise form disclosed. Those of skill in the art will recognize certain modifications, permutations, additions, and combinations of those embodiments are possible in light of the above teachings or may be acquired from practice of embodiments of the invention. Therefore, the present invention also covers various modifications and equivalent arrangements that fall within the purview of appended claims. Further, all patents, patent applications, and publications cited herein are incorporated herein by reference.

What is claimed is:

1. A method of distributing a video data file to a networked computer, the method comprising:
receiving a request for a toolbar from a client computer;
delivering a module to the client computer, the module adapted for installing the toolbar associated with a network browser on the client computer;
receiving a video data file from the client computer using the toolbar associated with the network browser on the client computer;
storing the video data file received from the client computer;
generating an HTML video snippet from the stored video data file, wherein the HTML video snippet enables accessing of the stored video data file; and
distributing the HTML video snippet to the client computer to enable placement of the HTML video snippet on a client webpage so as to enable the video data file to be played on the networked computer.

2. The method of claim 1, further comprising enabling rendering of the distributed HTML video snippet on the networked computer.

3. The method of claim 1, wherein distributed HTML video snippet is accessible on the networked computer to play the stored video data file received from the client computer.

4. The method of claim 1, wherein the delivering of the module to the client computer comprises sending the module from a server system to the client computer for installation as the toolbar thereon.

5. The method of claim 1, wherein the toolbar provides a toolbar graphical interface for integration into a browser application user interface, such that the toolbar graphical interface becomes a part of the browser application user interface.

6. The method of claim 1, further comprising enabling selective customization by the client computer of attributes of the toolbar.

7. The method of claim 1, further comprising viewing of the stored video data file on the networked computer.

8. A method of distributing a video data file to a viewer on a networked computer, the method comprising:
requesting download of a toolbar from a service provider computer to a publisher computer;
receiving a module adapted for installing the toolbar on the publisher computer;
installing the toolbar on a publisher computer;
selecting a video data file using the installed toolbar;
sending the selected video data file to the first computer using the toolbar;
receiving an HTML video snippet from the first computer; wherein the HTML video snippet enables accessing of the video data file on the first computer; and
placing the HTML video snippet on a web page to enable the video data file to be played on the networked computer.

9. The method of claim 8, wherein the first computer comprises a web application server.

10. A system for distributing a video data file to a networked computer, the system comprising:
a first computer that provides a module adapted for installation as a toolbar;
a second computer configured to operate with the first computer that receives a request from a client computer for the toolbar and delivers the module to the client computer to enable the client computer to transfer a video data file to the second computer using the toolbar; and
a third computer that distributes the video data file as an HTML video snippet to the networked computer.

11. The system of claim 10, wherein the first computer is a web application server, the second computer is a web services server, and third computer is a content server.

12. The system of claim 11, wherein the web application server provides a viewing module for rendering the distributed video snippet on the networked computer.

13. The system of claim 11, wherein the content server stores the transferred video data file.

14. The system of claim 11, wherein the web application server converts the received video data file from the client computer to the video snippet, wherein the video snippet is an HTML video snippet.

15. The system of claim 10, further comprising a database server for storing information regarding the video data file transferred from the client computer.

16. A method of distributing a video data file to a networked computer, the method comprising:
delivering a module to a publisher computer, wherein the module is adapted for installing a toolbar associated with a network browser on the publisher computer;
receiving a video data file from the publisher computer using the toolbar;
storing the video data file;
storing information regarding the video data file;
generating an HTML video snippet from the stored video data file, the HTML video snippet for providing access to the stored video data file; and
distributing the HTML video snippet to the publisher computer, so as to enable the HTML video snippet to be placed in a publisher web page that is accessible by the networked computer to enable the playing of the video data file.

17. The method of claim 16, further comprising enabling rendering of the distributed HTML video snippet on the networked computer.

18. A system for distributing a video data file to a networked computer, the system comprising:
a web application server for delivering a module to a client computer, the module adapted for installation as a toolbar on the client computer;
a web services server for receiving a video data file from the client computer using the toolbar; and
a content server for distributing the video data file as a video snippet to the client computer to enable the client computer to incorporate the video snippet in a web page that the networked computer accesses and receives.

19. The system of claim 18, wherein the web application server provides a viewing module for rendering the distributed video snippet on the networked computer.

20. The system of claim 18, wherein the content server stores the transferred video data file.

21. The system of claim 18, wherein the web application server calls the content server to provide the video data file for viewing on the networked computer.

22. The system of claim 18, further comprising a database server for storing information regarding the video data file transferred from the client computer.
